(19) United States
(12) Patent Application Publication
(10) Pub. No.: US 2008/0110079 A1
(43) Pub. Date: May 15, 2008

(54) FISHING TACKLE BOX WITH ARTIFICIAL LURE AND LIVE BAIT COMPARTMENTS

(76) Inventor: William M. Jeffries, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/558,594

(22) Filed: Nov. 10, 2006

(51) Int. Cl. A01K 97/04; A01K 97/06

(52) U.S. Cl. 43/55; 43/54.1

(57) ABSTRACT

A fishing tackle box for holding artificial lures and live bait. A tubular main housing has a plurality of compartments at one end selectively closed by a rotatable lid for storing artificial lures. A plurality of cavities located at the opposite end of the housing is closed by hingedly mounted covers for holding live bait.

### BACKGROUND OF THE INVENTION

1. Field of the Invention

The present invention relates generally to the field of receptacles having compartments and more specifically a fishing tackle box having pivotable and rotatable lids extending over compartments.

2. Description of the Prior Art

The typical fishing tackle box has a main compartment over which is placed a single or plurality of trays to hold the various lures, hooks, line, and other items typically used in the sport of fishing. Since the majority of the items stored in the box are contained in the main compartment, the various items become entangled and are not orderly stored. As a result, various boxes have been designed having separate compartments for storing specific items.

One device to provide an orderly storage of items used in fishing is disclosed in the U.S. Pat. No. 5,934,010 that has an internally mounted rotatable lure holder positioned within the tackle box. A device having a rotatably mounted holder for fishing hooks is shown in U.S. Pat. No. 6,134,825. A plurality of slidably mounted trays having individual compartments is shown in the U.S. Patent Application Publication US2005/0189246. A cylindrical tackle box with rotating storage trays is shown in U.S. Pat. No. 5,799,787. A cylindrical tube having interior compartments closed by an end cap specifically designed for ice fishing is shown in U.S. Pat. No. 5,967,315. A fishing tackle box having opposite ends that are rotatable to open and close compartments is shown in U.S. Pat. No. 4,813,173. From these references, it is seen that it is known to have a fishing tackle box having interior compartments which may be opened or closed by various means including a rotatable lid.

Typically, the fisherman will be carrying not only his fishing rod and reel, the fishing tackle box, but also a container of live bait. The bait may take several forms including items, such as, crickets and worms. Thus, it is conceivable that multiple live bait containers will be required. In addition, the fisherman may be carrying a cooler having food and/or drinks to support the fisherman during the trip. As a result, the fisherman is quite burdened since he or she carries many items. What is needed is a tackle box that will not only have compartments for artificial lures and other fishing items but also compartments for live bait. These compartments must be specifically designed for the items to be placed therein. Likewise, the tackle box should be designed to facilitate the ready removal of the artificial lures and live bait. The same technique for removal of artificial lures is not necessarily the best technique for removing live bait. I have invented such a tackle box and disclose same herein.

### SUMMARY OF THE INVENTION

One embodiment of the present invention is a combined fishing tackle box for artificial lures and live bait comprising a main housing with a first end and a second end. The housing has a plurality of compartments opening through the first end and a plurality of cavities opening through the second end for holding artificial lures and live bait. A first cover is rotatably mounted to the housing closing the compartments but movable to selectively open and allow access to a compartment. Second covers are pivotally mounted to the housing and have closed positions closing the cavities and movable to selectively open and allow access to the cavities.

It is an object of the present invention to provide a combined artificial lure and live bait fishing tackle box.

A further object of the present invention is to provide a new and improved tackle box.

Yet a further object of the present invention is to provide a tackle box that has means for allowing the fisherman to easily remove artificial lures and/or live bait.

Related objects and advantages of the present invention will be apparent from the following description.

### BRIEF DESCRIPTION OF THE DRAWINGS

FIG. 1 is a fragmentary view of a fishing tackle box incorporating the present invention.

FIG. 2 is an end view looking in the direction of arrows 2-2 of FIG. 1.

FIG. 3 is an end view looking in the direction of arrows 3-3 of FIG. 1.

FIG. 4 is a cross-sectional view taken along the line 4-4 of FIG. 1 and viewed in the direction of the arrows.

FIG. 5 is a cross-sectional view taken along the line 5-5 of FIG. 1 and viewed in the direction of the arrows.

FIG. 6 is an enlarged fragmentary view of the escape tube.

FIG. 7 is an enlarged view looking in the direction of arrow 7-7 of FIG. 3 showing a lock.

FIG. 8 is a side view of the lock of FIG. 7.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

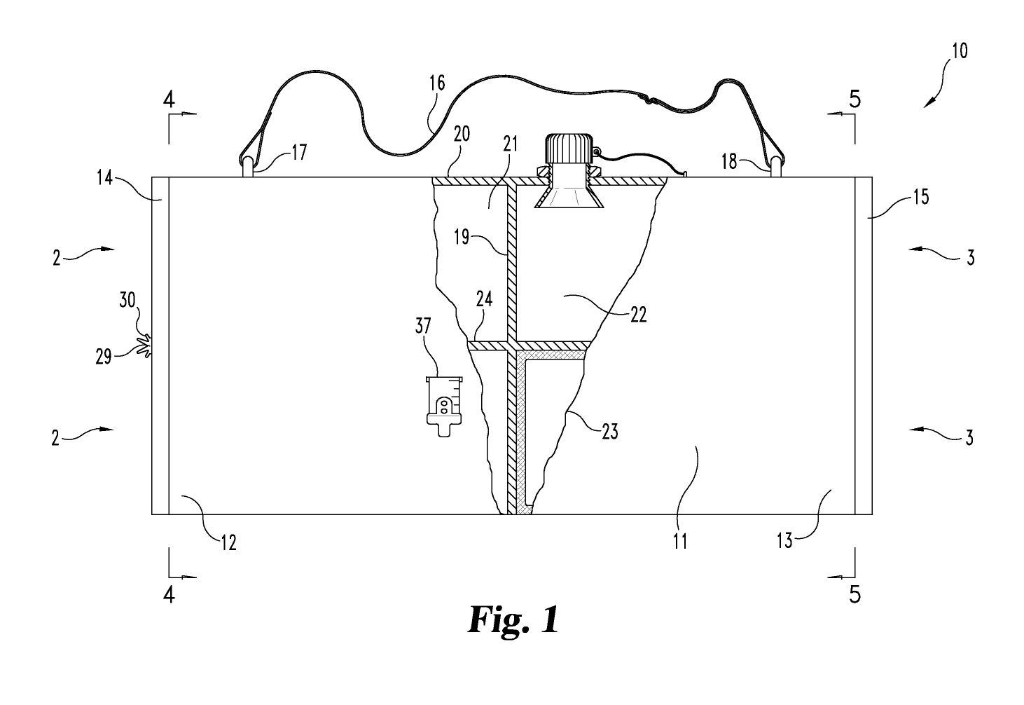

Referring now more particularly to FIG. 1, there is shown a fishing tackle box 10 having a housing 11 closed at ends 12 and 13 respectively by a first cover 14 and a plurality of second covers 15. A sling 16 consisting of a strap has its opposite ends mounted to a pair of brackets 17 and 18 fixed to the housing 11. Sling 16 allows the fishing tackle box to be conveniently carried.

The fishing tackle box 10 is designed to carry artificial lures, and other fishing equipment within the compartments formed in the housing closed by cover 14 with the exception that live bait is stored within the cavities formed in the opposite end of the main housing closed by covers 15. An intermediate wall 19 is integrally joined to the cylindrical sidewall 20 of housing 11 thereby dividing and separating compartments 21 from the cavities 22. Cylindrical sidewall 20 is shown fragmented in area 23 to more clearly illustrate the interior design although it is understood that the sidewall 20 is continuous extending from end 12 to end 13.

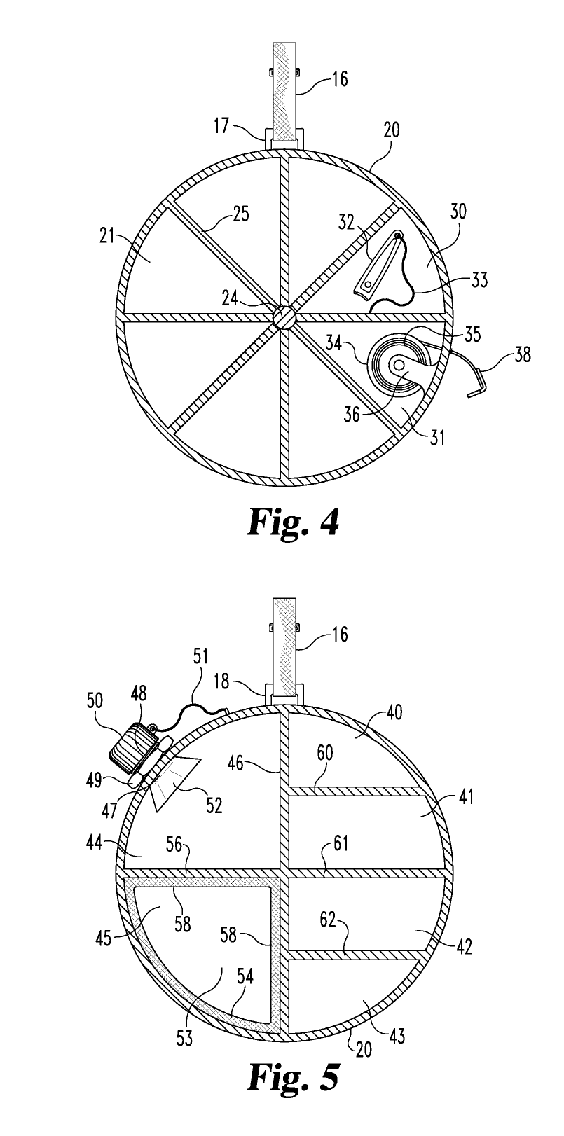

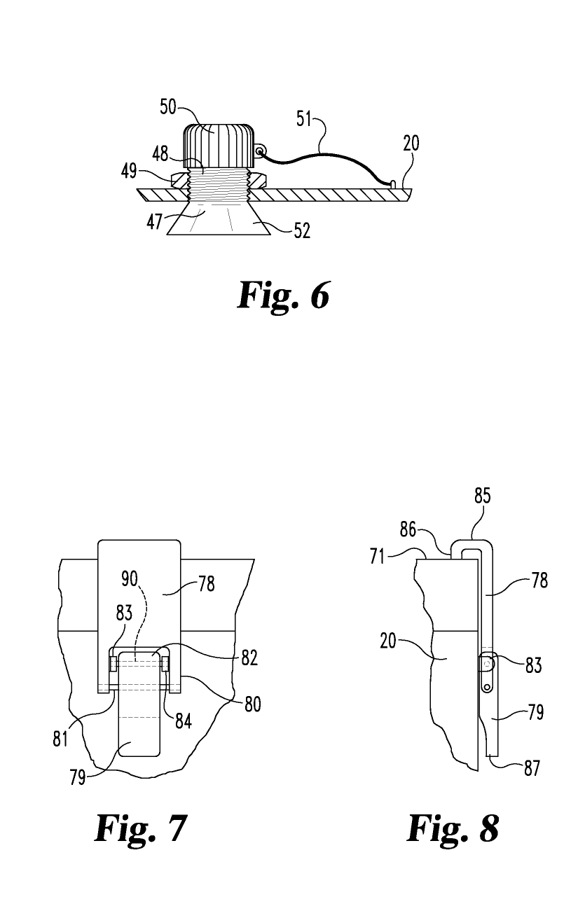

A shaft 24 is cantileverdly and integrally mounted to intermediate wall 19 and extends to housing end 12. A plurality of walls 25 (FIG. 4) extend radially outward from shaft 24 being integrally joined to the shaft and to sidewall 20. In the embodiment shown in the drawings, eight such radial walls 25 are shown dividing the compartments 21 formed between intermediate wall 19 and end 12 into eight separate compartments. It is understood that a number of compartments may be less than or greater than eight depending upon the number of radial walls utilized.

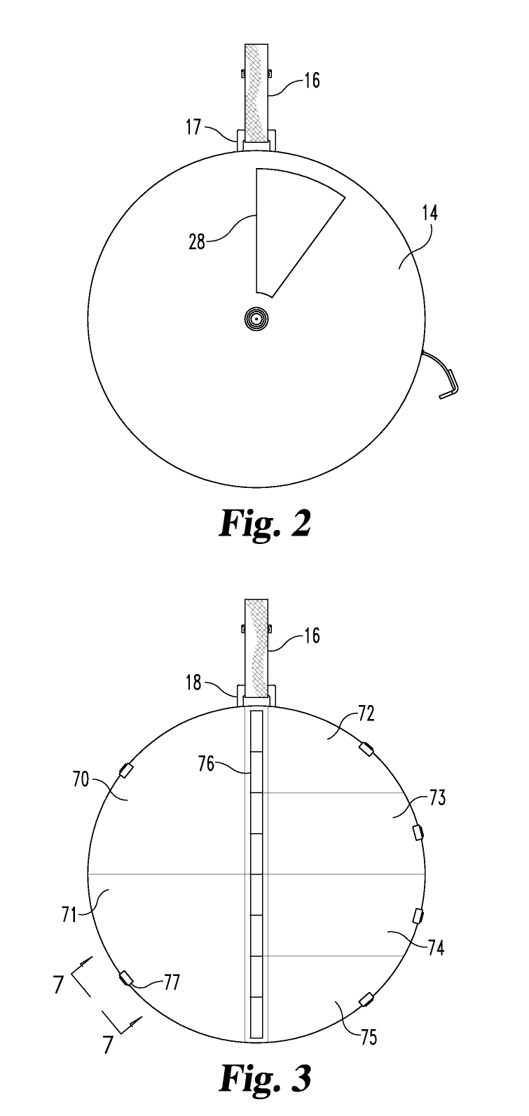

Disc shaped cover 14 is rotatably mounted to shaft 24 and has a generally pie shape opening 28 (FIG. 2) that may be selectively alignable with one of the compartments 21 while covering the remaining compartments allowing items to be inserted or removed from the particular compartment 21 aligned with opening 28. Cover 14 may be rotatably mounted to shaft 24 in any number of ways. For example, the end 29 (FIG. 1) of shaft 24 may be located outwardly of the cover having a plurality of flexible arms 30 that may be collapsed to allow end 29 to be inserted through or removed from a central hole of cover 14 aligned with shaft 24. Alternatively, end 29 may be a separate fastener that is threadedly received by an internally threaded outer end of shaft 24. The axis of rotation of cover 14 extends centrally and longitudinally through shaft 24 with wall 19 being perpendicular thereto.

Two compartments 30 and 31 of the plurality of compartments 21 are provided with special features. Compartment 30 (FIG. 4) includes a standard nail clipper 32 attached by a string or wire 33 to the radial wall 25. Normally, clipper 32 is stored within compartment 30; however, it may be pulled outwardly from the compartment when opening 28 is aligned with compartment 30. String or wire 33 has sufficient length to allow the clipper to be extended outwardly away from the housing for use.

Another compartment 31 includes a tape measure 34 extending wrappingly around a spool 35 rotatably mounted by a pair of brackets 36 fixed to sidewall 20. Sidewall 20 includes a slot 37 (FIG. 1) allowing the tape distal end 38 (FIG. 4) to extend therethrough. The outer portion of distal end 38 is enlarged to prevent the tape from moving completely into compartment 31. Tape 38 can be used to measure the length of various items including any fish that are caught.

The cavities 22 formed between intermediate wall 19 (FIG. 1) and covers 15 number six in total in the embodiment shown in FIG. 5 although it is to be understood that less than or more than six cavities are included in the present design. Cavities 40-45 are formed between the sidewall 20 of the housing, intermediate wall 19 and a plurality of partitions that extend from intermediate wall 19 to end 13. The main cavity is bisected by middle wall 46 thereby defining two larger cavities 44 and 45 that are used for live bait from the smaller cavities 40-43 that may be used as desired. Cavity 44 is designed to specifically hold crickets and has a funnel shaped tube 47 extending through sidewall 20. The outer distal end 48 of tube 47 threadedly receives a conventional fastening device, such as, a hexagonally shaped nut 49 securing the tube to the sidewall. The flared inner end 52 likewise limits relative movement between the tube and the sidewall. A removable cap 50 is mounted to tube 47 and may be secured to the sidewall by string or wire 51 to prevent the cap from becoming lost when it is removed from the tube. The inner end 52 of the tube is flared into a funnel shape thereby having a larger diameter as compared to the outer end 48. With the cover removed, the cricket or other such insect may therefore crawl through the tube and escape the cavity even though the covers 15 extend over cavities 40-45.

Cavity 45 is designed to hold items such as earthworms. It is desirable to insulate the earthworms from the outside temperature and thereby limit heat flow into the cavity preserving the earthworms. Thus, the bottom of cavity 45 formed by intermediate wall 19 is lined with heat insulation sheet 53. Likewise, the sidewall 20 is internally lined by the same type of heat insulation 54. Two additional pieces of heat insulation 58 are mounted internally to partition walls 56 and 46. Insulation portions 53, 54 and 58 thereby limit the amount of heat into the cavity.

Partition wall 56 is integrally mounted to sidewall 20 and wall 46 thereby dividing the left half of the cavity as viewed in FIG. 5 into two equal sides cavities 44 and 45. Three additional petition walls 60-62 are integrally attached to partition wall 46 and sidewall 20 thereby forming cavities 40-43.

Covers 15 in the embodiment shown in the drawings consist of six covers 70-75 (FIG. 3) hingedly mounted by a single panel hinge 76 that extends across the main housing at end 13. The hinge is fixedly mounted to sidewall 20. Covers 70-75 are sized to cover the cavity located immediately therebeneath as shown in FIG. 3. For example, cover 70 extends over cavity 44 whereas cover 75 extends over cavity 43.

A plurality of identical locks 77 are mounted to sidewall 20 and releasably hold the covers 70-75 in the closed position. Lock 77 associated with cover 71 will now be described it being understood that an identical description applies to the remaining five covers. Lock 77 has a latch 78 (FIGS. 7 & 8) with a top end 85 shaped as a hook extending over the top of cover 71 with the tip 86 of end 85 being in contact with the upper surface of cover 71 when the lock is in the locked position. The bottom end of lock 78 is bifurcated forming a pair of spaced apart flanges 80 having a pin 81 mounted thereto and spanning across the flanges through the main body of handle 79. Upstanding flanges 83 and 84 are fixedly mounted to the sidewall 20 of the tackle box. A pin 90 is fixedly mounted to flanges 83 and 84 and spans between the flanges through the top end 82 of handle 79. Handle 79 is therefore pivotally mounted to pin 90.

In order to operate lock 77, the bottom end 87 of handle 79 is pivoted in a counterclockwise direction as viewed in FIG. 8 about pin 90 thereby causing lock 78 to move vertically upward away from cover 71. Continual counterclockwise pivotal motion of the handle results in clockwise movement of lock 78 as viewed in FIG. 8 about pin 81 thereby allowing cover 71 to be pivoted to the open position.

Many variations are contemplated and included in the present invention. For example, the locks shown to secure the cover in place may be replaced by a variety of other lock designs.

The tackle box shown in the drawing is particularly useful for holding artificial lures in the compartments formed at end 12 of the box whereas live bait may be placed in the cavities located at end 13 of the tackle box. Cover 14 being rotatably mounted to the housing closes the compartments located at end 12 and is movable to selectively open and allow access to a compartment.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A combined fishing tackle box for artificial lures and live bait comprising:
a main housing with a first end and a second end, said housing having a plurality of compartments opening through said first end and a plurality of cavities opening through said second end for holding artificial lures and live bait;
a first cover rotatably mounted to said housing closing said compartments but movable to selectively open and allow access to a compartment of said compartments; and,
a plurality of second covers pivotally mounted to said housing and having closed positions closing said cavities and movable to selectively open and allow access to said cavities.

2. The tackle box of claim 1 wherein:
said housing has a hole extending out of at least one cavity of said cavities to external of said housing; and further comprising:
a third cover having a closed position blocking said hole and an open position allowing live bait within said one cavity to escape said one cavity to external of said housing while said second covers are in the closed position.

3. The tackle box of claim 2 and further comprising:
a mount on said housing and located at said first end with said first cover on said mount and having an axis of rotation; and wherein:
said housing has an outer wall extending around said compartments and said cavities from said first end to said second end, said housing further has a plurality of internal partitions extending radially from said mount outwardly to said outer wall defining said compartments with said outer wall;
said first cover includes an opening selectively alignable with a compartment allowing access thereto while remaining compartments are closed by said first cover.

4. The tackle box of claim 3 wherein:
said housing has an interior wall extending perpendicularly to said axis and separating said compartments from said cavities, and further comprising:
a sling mounted to said outer wall to facilitate carrying of the tackle box.

5. The tackle box of claim 4 and further comprising:
a plurality of locks mounted to said outer wall and engageable with said second covers for locking said covers in the closed positions but movable to allow said covers to be opened.

6. The tackle box of claim 5 and further comprising:
hinge means mounted to said housing at said second end, said second covers pivotally mounted by said hinge means to said housing.

7. The tackle box of claim 2 and further comprising:
a funnel mounted to said housing and having an outlet located at said hole and an inlet within said one cavity, said funnel being reduced in size at said outlet as compared to said inlet defining a passage for live bait within said one cavity to move through said hole and escape said one cavity when said third cover is in an open position.

8. The tackle box of claim 1 and further comprising:
a tape measure rotatably mounted to said housing which has a side wall, said measure located within one of said compartments and extendable outwardly though said side wall of said housing.

9. The tackle box of claim 1 and further comprising:
heat insulation mounted within one of said cavities to limit flow of external heat to items placed therein.

10. A container comprising:
a tubular main frame having first and second opposite ends and an intermediate wall located between said ends, said frame defining a first cavity extending from said intermediate wall to said first end and a second cavity extending from said intermediate wall to said second end, said first cavity and said second cavity opening respectively through said first and second opposite ends, said frame includes a shaft extending from said intermediate wall to said first end and a plurality of radial walls extending radially outwardly from said shaft dividing said first cavity into a plurality of compartments, said housing further has a plurality of partition walls extending from said intermediate wall to said second end dividing said second cavity into a plurality of partitioned spaces;
a lid rotatably mounted to said frame at said first end by said shaft and normally closing said compartments but having an opening selectable alignable with a compartment of said compartments to allow access thereto; and,
a plurality of closures hingedly mounted to said frame at said second end normally closing said partitioned spaces but movable to allow access thereto.

11. The container of claim 10 and further comprising:
a tube located in one of said partitioned spaces and opening outwardly from said main frame allowing items within one of said partitioned spaces to escape even though said closures are closed.

12. The container of claim 11 and further comprising:
a measuring device movably mounted within said main frame and extendable outwardly therefrom for measuring but retractable for storage.

13. The container of claim 11 wherein:
said tube includes an outer end that extends outwardly of said main frame and further comprising a cap removably mounted to said outer end to close or open said tube, said tube has an enlarged end located in said one of said partitioned spaces with said outer end smaller in size than said inner end.

14. The container of claim 13 and further comprising:
a measuring device movably mounted within one of said compartments and extendable outwardly therefrom for measuring but retractable for storage.

15. A fishing tackle box for holding artificial lures and live bait comprising:
a housing having a plurality of compartments with said compartments having openings through which items may be put into or removed from said compartments with one of said compartments being a live bait compartment with an escape hole;
a plurality of lids movably mounted to said housing having closed positions extending over said openings and open positions allowing access to items within said compartments; and,
a cap removably mounted to said housing at said escape hole and having a first position preventing live bait within one of said compartments from escaping said one compartment except through said escape hole when said cap is removed from said escape hole and said lids are closed.

16. The fishing tackle box of claim 15 wherein:
one of said lids is rotatably mounted to said housing with other of said lids pivotably mounted to said housing.

17. The fishing tackle box of claim 16 wherein:
some of said compartments open in an first direction and other of said compartments open in a second direction opposite from said first direction, said lid that is rotatably mounted extends over said compartments that open in said first direction whereas said lids that extend over said compartments opening in said second direction are pivotably mounted to said housing.

18. The fishing tackle box of claim 17 and further comprising:
an intermediate wall mounted to said housing and separating said compartments having said lid that is rotatably mounted from said compartments having said lids that are pivotally mounted.
